(19) United States
(12) Patent Application Publication
(10) Pub. No.: US 2003/0068453 A1
(43) Pub. Date: Apr. 10, 2003

(54) Multilayer sleeve labels

(76) Inventor: Dan-Cheng Kong, Fairport, NY (US)

Correspondence Address: ExxonMobil Chemical Company, P.O. Box 2149, Baytown, TX, 77522, US

(21) Appl. No.: 09/969,455

(22) Filed: Oct. 2, 2001

(51) Int. Cl. B32B 1/02; B32B 1/08

(52) U.S. Cl. 428/35.2; 428/36.9

(57) ABSTRACT

A thermoplastic sleeve label comprising a core layer comprising a blend of at least one polyolefin and at least one amorphous copolyester, wherein the core layer comprises the interior of the label; and a first skin layer comprising an amorphous copolyester, wherein the first skin layer is exterior to the core layer.

### BACKGROUND OF THE INVENTION

1. Field of the Invention

The invention relates to a shrinkable film comprising a base layer prepared from olefin-containing polymers, and a skin layer prepared from a copolyester. The invention also relates to a process for the manufacture of a film of this type and its use as shrink labels.

2. Description of the Prior Art

In many label applications, it is desirable that the label stock from which the labels are cut from a film of polymeric material rather than paper. Polymeric film can provide properties lacking in paper, such as durability, strength, water resistance, abrasion resistance, gloss, transparency and other properties. Obviously, the polymeric material must meet the practical requirements of commercial manufacture and use. Material costs must be competitive. The film must be formable by a suitable commercial process such as cast film extrusion or blown film extrusion, requiring that the molten film material be flowable to the correct degree to accomplish proper film formation. The formed film must be capable of hot-stretching without deleterious effect, since it is generally advantageous to hot-stretch and anneal the formed film, so as to orient the film and impart a stiffness to the film that is different in machine and cross directions.

It is already known to surround cylindrical or generally cylindrical packaging units, such as bottles or cans, with overall labels covering their entire circumference; these overall labels are called sleeves. The films used for this purpose are, for example, made of polyethylene, polybutylene, polystyrene, polyethylene-polypropylene copolymers, ethylene-vinyl acetate copolymers and various blends, but in particular of polyvinyl chloride. To obtain shrink properties of the films in the circumferential direction of the overall labels, which are appropriate for the intended purpose, the films are in general biaxially stretch-oriented, for example, according to the bubble, tenter or calender process, particular attention being paid to orientation in the transverse direction. In order to ensure an absolutely crease-free, close contact between the overall label and the packaging unit, the shrink values required are, for example: transverse shrink about 15 to 40% and longitudinal shrink not more than 2 to 5%, at a temperature of 90 degrees C. and a treating time of 15 minutes in a circulating air oven.

In addition, the shrink films are provided with a printing, for example by the reverse printing process, and are subsequently glued or welded to form a tubing. Due to the controlled transverse shrink, the tubing shrinks tightly and crease-free around the packaging unit in the shrink tunnel. The label is applied automatically with the aid of brushes or optionally also by hand. In addition to the desired shrink, the overall labels can possess some of the following properties: high gloss, optical clarity, good slip and rigidity for the automatic application of the label, good printability and good weldability/bondability.

For an economical fabrication of overall labels it is also advantageous to have heat-sealable films. Compared with gluing or welding, less time is required for sealing and, in addition, it is possible to save material.

There has been a trend in the packaging industry, and particularly in the beverage segment thereof, to replace inventory stock of lithographically preprinted cans with blank cans which can be filled as desired, the specific labeling being done by applying to the container a printed label formed from a heat shrink film some time soon before or after the filling operation. This technique is particularly attractive, for example, to breweries who often bottle and package their products under a variety of trade names. By utilizing the shrink labeling process, these bottlers would no longer be required to stock a large inventory of pre-printed containers for each brand and could, instead, stock only unprinted containers together with a supply of the appropriate heat shrinkable printed film labels. Moreover, the presence of the film label around the can would provide additional protection against the printed cans rubbing together during transport. Thus, surfaces of conventional lithographed cans are sufficiently abrasive such that the continuous contact with surrounding cans during shipping after causes small holes to be found in the cans, resulting in “leakers” which must be discarded.

U.S. Pat. No. 6,113,996 discloses a uniaxially heat-shrinkable, biaxially oriented, multilayer film having a polypropylene-containing core layer comprising at least 70 wt. % of said multilayer film and optionally, at least one polyolefin-containing skin layer adjacent said core layer, is prepared by biaxially orienting a coextrudate and therefore orienting said coextrudate by stretching 10 to 40 % in the machine direction. The core layer contains isotactic polypropylene and a sufficient amount of syndiotactic polypropylene to inhibit uniaxial heat shrinkage at temperature below about 50° C. The skin layer can be selected from the group consisting of polypropylene, ethylene-propylene copolymer, polyethylene, and ethylene-propylene-butylene terpolymer. U.S. Pat. No. 6,113,996 is incorporated herein by reference in its entirety.

U.S. Pat. No. 6,025,079 discloses a heat shrinkable multilayer film which includes a core layer including a blend having ethylene/propylene copolymer and propylene homopolymer, or ethylene/propylene/propylene/butene-1 terpolymer and propylene homopolymer; and two outer layers each including at least 50%, by weight of each respective outer layer, of ethylene/propylene/butene-1 terpolymer, ethylene/propylene copolymer, or a blend of ethylene/propylene/butene-1 terpolymer and ethylene/propylene copolymer. U.S. Pat. No. 6,025,079 is incorporated herein by reference in its entirety.

U.S. Pat. No. 5,958,581 discloses a polyester film made from a polymer having ethylene glycol moieties, isosorbide moieties and terepthaloyl moieties, and the method of making the film is described. The polyester film is used to form articles such as films, lacquers, labels, capacitors, insulators, and the like, and has an inherent viscosity of at least 0.35 dL/g when measured as a 1% (weight/volume) solution of the polyester in o-chlorophenol at a temperature of 25° C. U.S. Pat. No. 5,958,581 is incorporated herein by reference in its entirety.

U.S. Pat. No. 5,859,116 discloses a heat-shrinkable film which is made from a copolyester blend of 1 to 98.5 weight percent PETG amorphous copolyester, 98.5 to 1 weight DEG modified PET copolyester having a “bstar” value of less than 15, 0.5 to 3 weight percent anti-blocking agent, and optionally, 5 to 15 weight percent crystallizable polyester. The PETG copolyester has a dicarboxylic acid component of at least 95 mol percent terephthalic acid and a diol component of 65 to 80 mol percent ethylene glycol and 35 to 20 mol percent 1,4-cyclohexane-dimethanol. The DEG modified PET copolyester has a dicarboxylic acid component of at least 75 mol percent terephthalic acid; a diol component of 10 to 50 mol percent diethylene glycol and 50 to 90 mol percent ethylene glycol; catalyst residues of 20 to 100 ppm manganese, 50 to 300 ppm antimony, 0 to 100 ppm titanium and 40 to 150 ppm phosphorus; and color control agent residues of (i) 40 to 100 ppm cobalt, (ii) 1.5 to 10 ppm of blue compounds of substituted 1,4-bis(2,6-dialylanilino) anthraquinones and 0.5 to 6 ppm of red compounds of anthraquinones, or (iii) 0.5 to 10 ppm of 1-cyano-3H-dibenz isoquinoline-2,7-diones. U.S. Pat. No. 5,859,116 is incorporated herein by reference in its entirety.

U.S. Pat. No. 5,709,937 discloses a machine-direction oriented polypropylene homopolymer and propylene copolymer films wherein the propylene copolymer is one selected from the group consisting of propylene-ethylene copolymers containing up to about 10% by weight of ethylene and propylene-l-butene copolymers containing up to about 15% by weight of 1-butene wherein the oriented films has an opacity of less than about 10% and a haze of about 10% or less in the machine-direction and in the cross-direction. U.S. Pat. No. 5,709,937 is incorporated herein by reference in its entirety.

U.S. Pat. No. 5,524,778 discloses a container of thermoplastic material having a label which substantially covers the visible outer surface of the body of the container. The container is made either as a single layer or multi-layer extrusion. The layer of the container which is visible from the outside is made from 10% to 100% recycled plastic. The label is made of substantially the same material as the container so that both may be recycled without removing the label. U.S. Pat. No. 5,524,778 is incorporated herein by reference in its entirety.

U.S. Pat. No. 5,443,895 discloses a transparent shrinkable film comprising a base layer prepared from propylene-containing polymers and a hydrocarbon resin. The base layer contains about 5 to 40% by weight of a propylene homopolymer, 0 to about 30% by weight of a hydrogenated hydrocarbon resin having a softening point in the range from about 80° to 125° C., and about 30 to 95% by weight of a random ethylene-propylene copolymer, the percentages being related to the total weight of the mixture. A top layer is arranged on either side of the base layer. The invention also describes a process for the manufacture of the film. U.S. Pat. No. 5,443,895 is incorporated herein by reference in its entirety.

U.S. Pat. No. 5,252,155 discloses a process for applying heat shrink film to containers comprising the steps of a) coating at least a portion of a heat shrinkable but unshrunken film segment with a reactive hot melt polyurethane adhesive having a free isocyante content greater than 2% and a viscosity less than 3000 cps at 225° F.; b) applying the film to the longitudinal surface of the container; and, c) subjecting the container to heat to shrink the film onto the container so as to permanently affix it thereto. U.S. Pat. No. 5,252,155 is incorporated herein by reference in its entirety.

U.S. Pat. No. 4,025,378 discloses a method for attaching a polyethylene sleeve label to a polyethylene bottle, the label having on the outer surface thereof means for absorbing heat in local, discrete areas of the label at a rate greater than that of other areas of the label; and means for welding the label to the body at the junction of the outer surface of the body and the inner surface of the label, adjacent the local heat-absorbing areas. U.S. Pat. No. 4,025,378 is incorporated herein by reference in its entirety.

U.S. Pat. No. 4,585,679 discloses a coextruded multilayer heat shrunk plastic sleeve label having a tough skin layer and a brittle polystyrene foam layer, the skin layer being extruded from a blend of low density polyethylene, a block copolymer of butadiene and styrene as a compatibility agent and optionally, small amounts of polystyrene. The amount of the block copolymer used is sufficient to provide limited adhesion between the skin and foam layers to maximize the toughness of the total label structure. The sleeve label can be sealed by ultrasonic, hot air and heat sealing. U.S. Pat. No. 4,585,679 is incorporated herein by reference in its entirety.

U.S. Pat. No. 4,463,861 discloses a sleeve and method of making the same comprising a laminate sheet having a more highly shrinkable foamed film and a lesser shrinkable non-foamed film, the ends of the laminate being bonded together so that the foamed film faces the interior of the sleeve. The foamed film has a thicker surface layer on its side opposite that laminated to the non-foamed layer, which therefore faces the interior of the sleeve. The flow direction shrinkage rate of the laminated sheet, which is 60% or less, is greater than the widthwise shrinkage rate of the laminated film. The widthwise shrinkage rate is 10% or less. U.S. Pat. No. 4,463,861 is incorporated herein by reference in its entirety.

U.S. Pat. No. 5,575,096 discloses a sleeve for placement around a container utilizes a single continuous sheet of plastic which is folded into an enclosed shape having a front side, a back side and an overlapping section extending over the front side to form a sleeve body. This enclosed shape is held together by welds formed through adjacent edges of the front and back sides and the overlapping section. At least one precut is formed in the overlapping section. This precut extends parallel to the welds to allow for detachment of a portion of the overlapping section such that the front side is visible. Information can be printed both on the overlapping section and on the front and back sides, so that the sleeve of the invention has a larger surface area for printing than conventional sleeves which include only front and back portions. U.S. Pat. No. 5,575,096 is incorporated herein by reference in its entirety.

### SUMMARY OF THE INVENTION

Accordingly, it is an object of the present invention to provide a thermoplastic sleeve label comprising a core layer comprising a polymer selected from the group consisting of polyolefins, amorphous copolyesters, and blends thereof, wherein the core layer comprises the interior of the label; and a first skin layer comprising an amorphous copolyester, wherein the first skin layer is exterior to the core layer.

There has been provided, in accordance with one aspect of the present invention, a shrinkable film comprising a core layer comprising polyethylene or a copolymer ethylene and other olefin(s); and a skin layer comprising an amorphous copolyester.

In accordance with another aspect of the present invention there is provided a process for producing the foregoing film which comprises the steps of producing a cast film by coextrusion through a slot die, solidifying the cast film on a chill roll and orienting the film by stretching in the longitudinal and transverse directions, wherein longitudinal stretching is carried out at a temperature between about 160° F. and about 240° F. and at a stretching ratio of less than 3; and wherein transverse stretching is carried out at a temperature between about 220° F. and about 320° F. at a stretching ratio of more than about 6.

Advantages of the thermoplastic label include one or more of the following:

1. High surface energy for printing

2. Lower shrink force than an OPP shrink label

3. A label material that is better for the environment than a polyvinyl chloride label.

4. A label that can be recycled with the plastic container without having to be removed.

5. A film that possesses good bonding characteristics.

6. A film that possesses good shrinking characteristics.

7. A film that possesses good optical and mechanical properties.

8. A film that is sealable.

9. A process for producing a film that possesses one or more of the aforementioned properties.

Other objects, features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of several illustrative embodiments when read in conjunction with the accompanying drawings, wherein:

FIG. 1 is a cross sectional view of a two layered film;

FIG. 2 is a cross sectional view of a three layered film;

FIG. 3 is a cross sectional view of a four layered film; and

FIG. 4 is a cross sectional view of a five layered film.

### DETAILED DESCRIPTION OF THE DRAWINGS

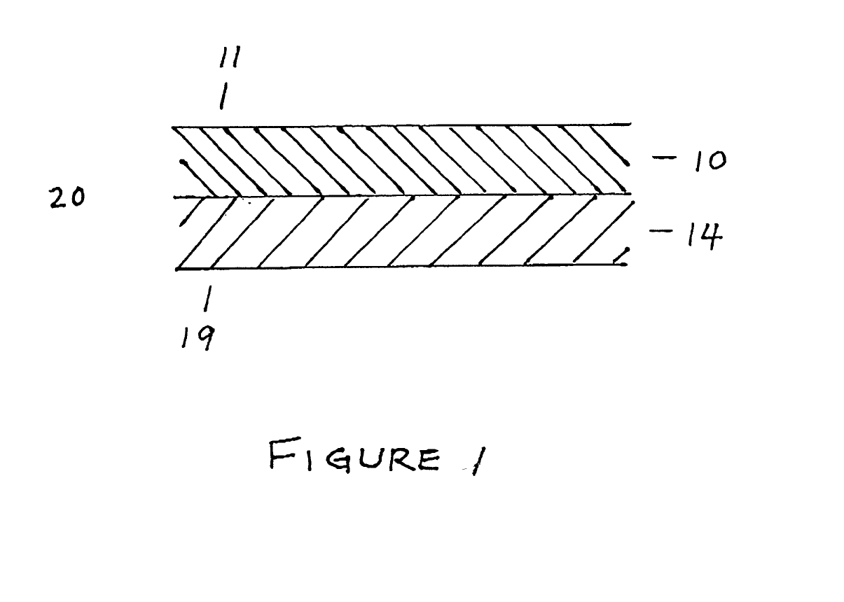

Referring now to FIG. 1 is a cross sectional view of a two layered film 20. The film 20 is comprised of a first surface 11, a first skin layer 10, a core layer 14, and a second surface 19. The films in accordance with the present invention may be constructed in a variety of thicknesses. In one aspect of the invention the films and the labels made form the films may have thicknesses ranging for 1 to 10 mils. In another aspect of the invention, the films and labels made for the films may have thicknesses ranging from 1.5 to 5 mils.

A first embodiment of a two layered film 20 has a first skin layer 10 having a first side and a second side and a core layer 14 having a first side and a second side wherein the first side of the core layer is adjacent to the second side of the first skin layer. In another embodiment, the interior of the film comprises a core layer 14 having a first side and a second side. Exterior to the first side of the core layer 14 is a first skin layer 10.

Suitable materials for the core layer 14 include polyethylene, polypropylene, and copolymers of ethylene and one or more alpha-olefin(s). In one embodiment the core layer 14 comprises a material selected from the group consisting of high-density polyethylene, medium-density polyethylene, linear low-density polyethylene, ethylene-propylene copolymer, ethylene-butene copolymer, ethylene-octene copolymer, ethylene-propylene-butylene terpolymer, or other copolymers of ethylene and one or more alpha-olefins having from 3 to 20 carbon atoms, or polybutylene. In another embodiment the core layer 14 comprises an ethylene-octene copolymer. In one embodiment the polymer is polymerized by a metallocene catalyst, in another embodiment the polymer is polymerized by a Ziegler-Natta catalyst. In another embodiment, the core layer 14 further comprises an amorphous copolyester. In another embodiment, the core layer 14 comprises a blend of a copolyester and a polyolefin; in one embodiment from about 10% to about 90% by weight copolyester and from about 10% to about 90% by weight polyolefin; and in a second embodiment from about 40% to about 60% by weight copolyester and from about 40% to about 60% by weight polyolefin.

The first skin layer 10 comprises a copolyester. Copolyesters are disclosed in U.S. Pat. No. 5,859,116, which is incorporated herein by reference in its entirety. Another embodiment comprises an acid/acrylate grafted plastomer.

Alternatively, the two layered film described with reference to FIG. 1 may also comprise a tie or transition layer positioned between the core layer and the skin layer. The transition layer may comprise a blend of the material used for the core layer and an acid/acrylate grafted plastomer. In another embodiment, the transition layer comprises any of the polymeric materials used in the art. Examples of such polymeric materials which can be used include olefinic homo-, co- or terpolymers. The olefinic monomers can comprise 2 to 8 carbon atoms. Specific examples include polypropylene, ethylene-propylene random copolymer, ethylene-butene-1 copolymer, ethylene-propylene-butene-1 terpolymer, propylene-butene copolymer, high density polyethylene, low density polyethylene, linear low density polyethylene, very low density polyethylene, metallocene-catalyzed polyethylene, metallocene-catalyzed polymers known by the term plastomer, metallocene-catalyzed ethylene-hexene copolymer, metallocene-catalyzed ethylene-butene copolymer, metallocene-catalyzed ethylene-octene copolymer, ethylene-methacrylic acid copolymer, ethylene-vinyl acetate copolymer and ionomer resin. A blend of the foregoing materials is also contemplated such as a blend of the plastomer and ethylene-butene copolymer.

In one aspect of the invention, the tie or transitional layers in accordance with the present invention may have thicknesses of at least 0.1 mil. In another aspect of the invention, the tie or transition layers have thicknesses of at least 0.3 mil.

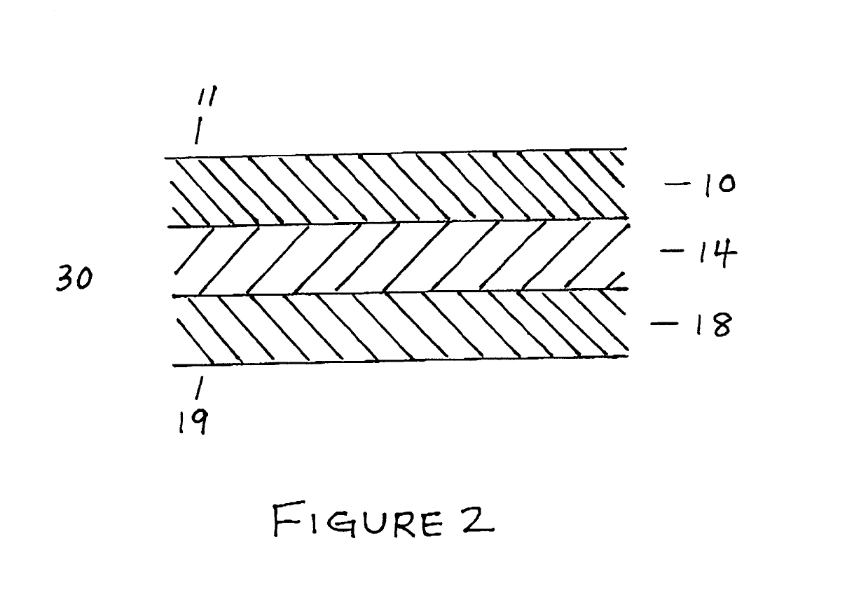

Referring now to FIG. 2 is a cross sectional view of a three layered film 30. The film 30 is comprised of a first surface 11, a first skin layer 10, a core layer 14, a second skin layer 18, and a second surface 19.

A first embodiment of a three layered film 30 has a first skin layer 10 having a first side and a second side, a core layer 14 having a first side and a second side wherein the first side of the core layer 14 is adjacent to the second side of the first skin layer 10, and a second skin layer 18 having a first side and a second side, wherein the first side of the second skin layer 18 is adjacent to the second side of the core layer 14. In another embodiment, the interior of the film comprises a core layer 14 having a first side and a second side. Exterior to the first side of the core layer 14 is a first skin layer 10. Exterior to the second side of the core layer 14 is a second skin layer 18.

Suitable materials for the core layer 14 include polyethylene, polypropylene, and copolymers of ethylene and one or more alpha-olefin(s). In one embodiment the core layer 14 comprises a material selected from the group consisting of high-density polyethylene, medium-density polyethylene, linear low-density polyethylene, ethylene-propylene copolymer, ethylene-butene copolymer, ethylene-octene copolymer, ethylene-propylene-butylene terpolymer, or other copolymers of ethylene and one or more alpha-olefins having from 3 to 20 carbon atoms, or polybutylene. In another embodiment the core layer 14 comprises an ethylene-octene copolymer. In one embodiment the polymer is polymerized by a metallocene catalyst, in another embodiment the polymer is polymerized by a Ziegler-Natta catalyst. In another embodiment, the core layer 14 further comprises an amorphous copolyester. In another embodiment, the core layer 14 comprises a blend of a copolyester and a polyolefin; in one embodiment from about 10% to about 90% by weight copolyester and from about 10% to about 90% by weight polyolefin; and in a second embodiment from about 40% to about 60% by weight copolyester and from about 40% to about 60% by weight polyolefin.

In another embodiment, the first skin layer 10 may comprise a copolyester. Copolyesters are disclosed in U.S. Pat. No. 5,859,116, which is incorporated herein by reference in its entirety. In another embodiment the first skin layer 10 comprises an acid/acrylate grafted plastomer. The first skin layer 10 comprises a blend of a copolyester and an acid/acrylate grafted plastomer. In another embodiment, the first skin layer 10 comprises a blend of about 60% to about 95% copolyester by weight of the first skin layer 10 and about 5% to about 40% of an acid/acrylate grafted plastomer by weight of the first skin layer 10.

The second skin layer 18 may comprise a copolyester. Copolyesters are disclosed in U.S. Pat. No. 5,859,116, which is incorporated herein by reference in its entirety. In another embodiment the second skin layer 18 comprises an acid/acrylate grafted plastomer. In another embodiment, the second skin layer 18 comprises a blend of a copolyester and an acid/acrylate grafted plastomer. In another embodiment, the second skin layer 18 comprises a blend of about 60% to about 95% copolyester by weight of the second skin layer 18 and about 5% to about 40% of an acid/acrylate grafted plastomer by weight of the second skin layer 18.

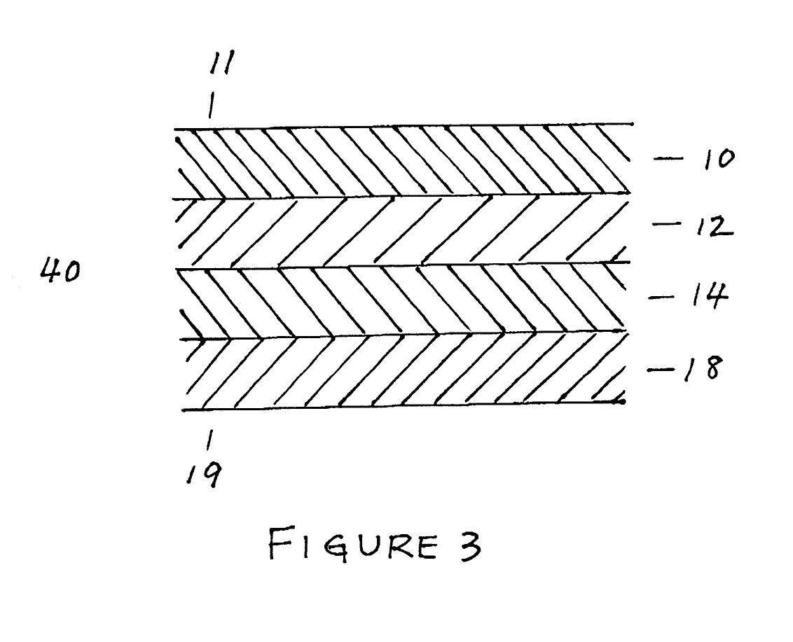

Referring now to FIG. 3 is a cross sectional view of a four layered film 40. The film 40 is comprised of a first surface 11, a first skin layer 10, a first transition layer 12, a core layer 14, a second skin layer 18, and a second surface 19.

A first embodiment of a four layered film 40 has a first skin layer 10 having a first side and a second side, a first transition layer 12 having a first side and a second side wherein the first side of the first transition layer 12 is adjacent to the second side of the first skin layer 10, a core layer 14 having a first side and a second side wherein the first side of the core layer 14 is adjacent to the second side of the first transition layer 12, and a second skin layer 18 having a first side and a second side, wherein the first side of the second skin layer 18 is adjacent to the second side of the core layer 14. In another embodiment, the interior of the film comprises a core layer 14 having a first side and a second side. Exterior to the first side of the core layer 14 is a first transition layer 12, and exterior to the first side of the core layer 14 and the first transition layer 12 is a first skin layer 10. Exterior to the second side of the core layer 14 is a second skin layer 18.

Suitable materials for the core layer 14 include polyethylene, polypropylene, and copolymers of ethylene and one or more alpha-olefin(s). In one embodiment the core layer 14 comprises a material selected from the group consisting of high-density polyethylene, medium-density polyethylene, linear low-density polyethylene, ethylene-propylene copolymer, ethylene-butene copolymer, ethylene-octene copolymer, ethylene-propylene-butylene terpolymer, or other copolymers of ethylene and one or more alpha-olefins having from 3 to 20 carbon atoms, or polybutylene. In another embodiment the core layer 14 comprises an ethylene-octene copolymer. In one embodiment the polymer is polymerized by a metallocene catalyst, in another embodiment the polymer is polymerized by a Ziegler-Natta catalyst. In another embodiment, the core layer 14 further comprises an amorphous copolyester. In another embodiment, the core layer 14 comprises a blend of a copolyester and a polyolefin; in one embodiment from about 10% to about 90% by weight copolyester and from about 10% to about 90% by weight polyolefin; and in a second embodiment from about 40% to about 60% by weight copolyester and from about 40% to about 60% by weight polyolefin.

The first skin layer 10 may comprise a copolyester. Copolyesters are disclosed in U.S. Pat. No. 5,859,116, which is incorporated herein by reference in its entirety. In another embodiment the first skin layer 10 comprises an acid/acrylate grafted plastomer. In another embodiment, the first skin layer 10 comprises a blend of a copolyester and an acid/acrylate grafted plastomer. In another embodiment, the first skin layer 10 comprises a blend of about 60% to about 95% copolyester by weight of the first skin layer 10 and about 5% to about 40% of an acid/acrylate grafted plastomer by weight of the first skin layer 10.

In one embodiment, the first transition layer 12 comprises a blend of the material used for the core layer 14 and an acid/acrylate grafted plastomer. In another embodiment, the first transition layer 12 comprises any of the polymeric materials used in the art. Examples of such polymeric materials which can be used include olefinic homo-, co- or terpolymers. The olefinic monomers can comprise 2 to 8 carbon atoms. Specific examples include polypropylene, ethylene-propylene random copolymer, ethylene-butene-1 copolymer, ethylene-propylene-butene-1 terpolymer, propylene-butene copolymer, high density polyethylene, low density polyethylene, linear low density polyethylene, very low density polyethylene, metallocene-catalyzed polyethylene, metallocene-catalyzed polymers known by the term plastomer, metallocene-catalyzed ethylene-hexene copolymer, metallocene-catalyzed ethylene-butene copolymer, metallocene-catalyzed ethylene-octene copolymer, ethylene-methacrylic acid copolymer, ethylene-vinyl acetate copolymer and ionomer resin. A blend of the foregoing materials is also contemplated such as a blend of the plastomer and ethylene-butene copolymer.

The second skin layer 18 may comprise a copolyester. Copolyesters are disclosed in U.S. Pat. No. 5,859,116, which is incorporated herein by reference in its entirety. In another embodiment the second skin layer 18 comprises an acid/acrylate grafted plastomer. In another embodiment, the second skin layer 18 comprises a blend of a copolyester and an acid/acrylate grafted plastomer. In another embodiment, the second skin layer 18 comprises a blend of about 60% to about 95% copolyester by weight of the second skin layer 18 and about 5% to about 40% of an acid/acrylate grafted plastomer by weight of the second skin layer 18.

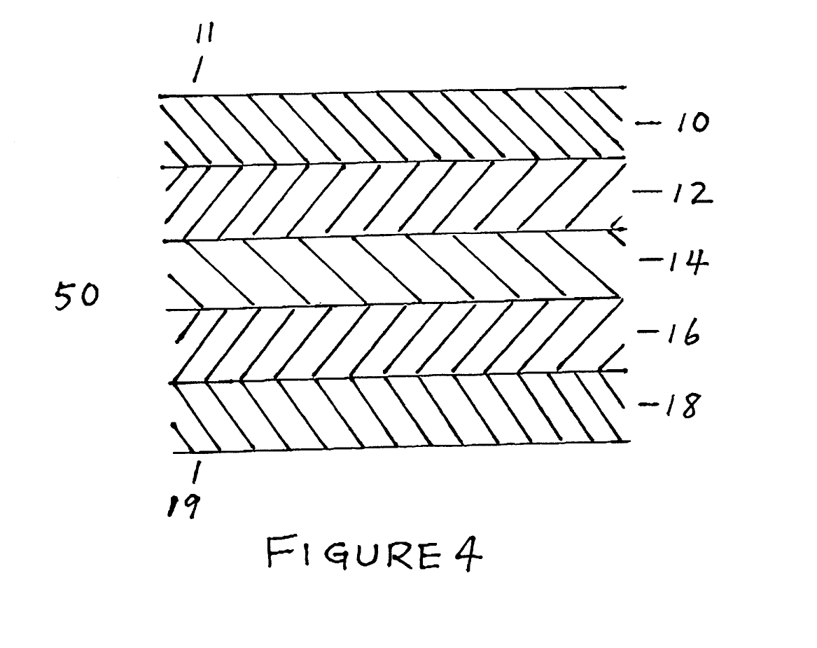

Referring now to FIG. 4 is a cross sectional view of a five layered film 50. The film 50 is comprised of a first surface 11, a first skin layer 10, a first intermediate or transition layer 12, a core layer 14, a second intermediate or transition layer 16, a second skin layer 18, and a second surface 19.

A first embodiment of a five layered film 50 has a first skin layer 10 having a first side and a second side, a first transition layer 12 having a first side and a second side wherein the first side of the first transition layer 12 is adjacent to the second side of the first skin layer 10, a core layer 14 having a first side and a second side wherein the first side of the core layer 14 is adjacent to the second side of the first transition layer 12, a second transition layer 16 having a first side and a second side wherein the first side of the second transition layer 16 is adjacent to the second side of the core layer 14, and a second skin layer 18 having a first side and a second side, wherein the first side of the second skin layer 18 is adjacent to the second side of the second transition layer 16. In another embodiment, the interior of the film comprises a core layer 14 having a first side and a second side. Exterior to the first side of the core layer 14 is a first transition layer 12, and exterior to the first side of the core layer 14 and the first transition layer 12 is a first skin layer 10. Exterior to the second side of the core layer 14 is a second transition layer 16, and exterior to the second side of the core layer 14 and the second transition layer 16 is a second skin layer 18.

Suitable materials for the core layer 14 include polyethylene, polypropylene, and copolymers of ethylene and one or more alpha-olefin(s). In one embodiment the core layer 14 comprises a material selected from the group consisting of high-density polyethylene, medium-density polyethylene, linear low-density polyethylene, ethylene-propylene copolymer, ethylene-butene copolymer, ethylene-octene copolymer, ethylene-propylene-butylene terpolymer, or other copolymers of ethylene and one or more alpha-olefins having from 3 to 20 carbon atoms, or polybutylene. In another embodiment the core layer 14 comprises an ethylene-octene copolymer. In one embodiment the polymer is polymerized by a metallocene catalyst, in another embodiment the polymer is polymerized by a Ziegler-Natta catalyst. In another embodiment, the core layer 14 further comprises an amorphous copolyester. In another embodiment, the core layer 14 comprises a blend of a copolyester and a polyolefin; in one embodiment from about 10% to about 90% by weight copolyester and from about 10% to about 90% by weight polyolefin; in a second embodiment from about 40% to about 60% by weight copolyester and from about 40% to about 60% by weight polyolefin; and in a third embodiment from about 10% to about 70% by weight copolyester and from about 30% to about 90% by weight polyolefin.

The first skin layer 10 may comprise a copolyester. Copolyesters are disclosed in U.S. Pat. No. 5,859,116, which is incorporated herein by reference in its entirety. In another embodiment the first skin layer 10 comprises an acid/acrylate grafted plastomer. In another embodiment, the first skin layer 10 comprises a blend of a copolyester and an acid/acrylate grafted plastomer. In another embodiment, the first skin layer 10 comprises a blend of about 60% to about 95% copolyester by weight of the first skin layer 10 and about 5% to about 40% of an acid/acrylate grafted plastomer by weight of the first skin layer 10.

In one embodiment, the first transition layer 12 comprises a blend of the material used for the core layer 14 and an acid/acrylate grafted plastomer. In another embodiment, the first transition layer 12 comprises any of the polymeric materials used in the art. Examples of such polymeric materials which can be used include olefinic homo-, co- or terpolymers. The olefinic monomers can comprise 2 to 8 carbon atoms. Specific examples include polypropylene, ethylene-propylene random copolymer, ethylene-butene-1 copolymer, ethylene-propylene-butene-1 terpolymer, propylene-butene copolymer, high density polyethylene, low density polyethylene, linear low density polyethylene, very low density polyethylene, metallocene-catalyzed polyethylene, metallocene-catalyzed polymers known by the term plastomer, metallocene-catalyzed ethylene-hexene copolymer, metallocene-catalyzed ethylene-butene copolymer, metallocene-catalyzed ethylene-octene copolymer, ethylene-methacrylic acid copolymer, ethylene-vinyl acetate copolymer and ionomer resin. A blend of the foregoing materials is also contemplated such as a blend of the plastomer and ethylene-butene copolymer. In another embodiment, the first transition layer 12 comprises a blend of a copolyester and a polyolefin; in one embodiment from about 30% to about 70% by weight copolyester and from about 30% to about 70% by weight polyolefin; and in a second embodiment from about 40% to about 60% by weight copolyester and from about 40% to about 60% by weight polyolefin.

In one embodiment, the second transition layer 16 comprises a blend of the material used for the core layer 14 and an acid/acrylate grafted plastomer. In another embodiment, the second transition layer 16 comprises any of the polymeric materials used in the art. Examples of such polymeric materials which can be used include olefinic homo-, co- or terpolymers. The olefinic monomers can comprise 2 to 8 carbon atoms. Specific examples include polypropylene, ethylene-propylene random copolymer, ethylene-butene-1 copolymer, ethylene-propylene-butene-1 terpolymer, propylene-butene copolymer, high density polyethylene, low density polyethylene, linear low density polyethylene, very low density polyethylene, metallocene-catalyzed polyethylene, metallocene-catalyzed polymers known by the term plastomer, metallocene-catalyzed ethylene-hexene copolymer, metallocene-catalyzed ethylene-butene copolymer, metallocene-catalyzed ethylene-octene copolymer, ethylene-methacrylic acid copolymer, ethylene-vinyl acetate copolymer and ionomer resin. A blend of the foregoing materials is also contemplated such as a blend of the plastomer and ethylene-butene copolymer. In another embodiment, the second transition layer 16 comprises a blend of a copolyester and a polyolefin; in one embodiment from about 30% to about 70% by weight copolyester and from about 30% to about 70% by weight polyolefin; and in a second embodiment from about 40% to about 60% by weight copolyester and from about 40% to about 60% by weight polyolefin.

The second skin layer 18 may comprise a copolyester. Copolyesters are disclosed in U.S. Pat. No. 5,859,116, which is incorporated herein by reference in its entirety. In another embodiment the second skin layer 18 comprises an acid/acrylate grafted plastomer. In another embodiment, the second skin layer 18 comprises a blend of a copolyester and an acid/acrylate grafted plastomer. In another embodiment, the second skin layer 18 comprises a blend of about 60% to about 95% copolyester by weight of the second skin layer 18 and about 5% to about 40% of an acid/acrylate grafted plastomer by weight of the second skin layer 18.

In another embodiment, the core layer 14 of film 50, film 40, film 30, and/or film 20 comprises from about 20% to about 80% by weight of the core of polyethylene or an ethylene-alpha olefin copolymer (where the alpha olefin has from 3 to 20 carbon atoms), where the polymer has a density from about 0.915 g/cc to about 0.960 g/cc; the core layer also comprises from about 20% to about 80% by weight of the core of an amorphous copolyester, such as Eastman Embrace P21214 or Eastman Eastar PETG6763. It should be noted that the core layer may contain other materials in addition to the materials broadly described above, so long as these other materials do not unduly interfere with achieving the desired advantages of the invention.

In another embodiment, the first skin layer 10 and/or the second skin layer 18 of film 50, film 40, film 30, and/or film 20 may comprise from about 70% to about 100% by weight of the skin layer of an amorphous copolyester; and from about 0% to about 30% by weight of the skin layer of an acid/acrylate grafted plastomer, or ethylene-methylacrylate-glycidyl methacrylate terpolymer.

In one embodiment, the core layer 14 thickness is from about 50% to about 80% of the total film thickness.

In another embodiment, a conventional filler and pigment such as titanium dioxide may be added to the core layer 14 and may be desirable for printing or graphic reproduction purposes. White or colored pigments are contemplated for use in the core layer 14. Generally, from an economic viewpoint at least it has not been considered to be of any particular advantage to use more than about 10 percent by weight of titanium dioxide to achieve a white label suitable for printing, although greater amounts could be added for greater opacity so long as there is no undue interference with achieving the desired properties of the thermoplastic label.

In another embodiment of the invention the first skin layer 10 does not contain titanium dioxide, and the titanium dioxide pigment is contained only in the core layer 14. It has been found in this regard that titanium dioxide tends to build up on a die lip over time where it is not isolated in the core layer 14 of the film, and eventually breaks off into the film. As a consequence, where the titanium dioxide has not been so isolated, it has been necessary to periodically stop production of the film and remove the materials built up on the die lip.

In one embodiment, the film is uniaxially oriented. In another embodiment, the film is uniaxially oriented from about 1.1 to about 6 times in the machine direction. In another embodiment, the film is biaxially oriented. In another embodiment, the film is biaxially oriented from about 1.1 to about 6 times in the machine direction and from about 2 to about 10 times in the transverse direction. In another embodiment, the film orientation ratio is less than about 3 times in the machine direction and more than about 4 times in the transverse direction.

In another embodiment, the first side 11 of the first skin layer 10 is printable. In one embodiment, the first side 11 of the first skin layer 10 is treated by flame, corona, or plasma treatment to enhance the surface energy for ink printing.

In another embodiment, the sleeve tube may be made by a lap-seal of the film with THF solvent or heat on the edge of the film.

Sometimes it is useful to enhance film properties or provide the film with certain properties by use of appropriate film additives. Such additives are used in effective amounts, which vary depending upon the property required, and are, typically selected from the group consisting of: antiblock, slip additive, antioxidant additive, moisture barrier additive or gas barrier additive. These additives may be included in any of the film's layers. Useful antistatic additives which can be used in amounts ranging from about 0.05 to about 3 weight %, based upon the weight of the layer, include alkali metal sulfonates, polyether-modified polydiorganosiloxanes, polyalkylphenylsiloxanes and tertiary amines. Useful antiblock additives used in amounts ranging from about 0.1 weight % to about 3 weight % based upon the entire weight of the layer include inorganic particulates such as silicon dioxide, e.g. a particulate antiblock sold by W. R. Grace under the trademark “Sylobloc 44,” calcium carbonate, magnesium silicate, aluminum silicate, calcium phosphate, and the like, e.g., KAOPOLITE. Another useful particulate antiblock agent is referred to as a non-meltable crosslinked silicone resin powder sold under the trademark “TOSPEARL” made by Toshiba Silicone Co., Ltd. and is described in U.S. Pat. No. 4,769,418. Another useful antiblock additive is a spherical particle made from methyl methacrylate resin having an average diameter of 1 to 15 microns, such an additive is sold under the trademark “EPOSTAR” and is commercially available from Nippon Shokubai. Typical slip additives include higher aliphatic acid amides, higher aliphatic acid esters, waxes and metal soaps which can be used in amounts ranging from about 0.1 to about 2 weight percent based on the total weight of the layer. A specific example of a useful fatty amide slip additive is erucamide. Useful antioxidants are generally used in amounts ranging from about 0.1 weight % to about 2 weight percent, based on the total weight of the layer, phenolic antioxidants. One useful antioxidant is commercially available under the trademark “Irganox 1010”. Barrier additives may be used in useful amounts and may include low-molecular weight resins, hydrocarbon resins, particularly petroleum resins, styrene resins, cyclopentadiene resins and terpene resins. Optionally, one or more of the film's layers may be compounded with a wax for lubricity. Amounts of wax range from about 2 to about 15 weight % based on the total weight of the layer. Any conventional wax useful in thermoplastic films is contemplated.

It should be evident that this disclosure is by way of example, and that various changes can be made by adding, modifying, or eliminating details without departing from the fair scope of the teaching contained in the disclosure. The invention therefore is not limited to particular details of this disclosure except to the extent that the claims that follow are necessarily so limited.

### EXAMPLES

### Example 1

A five layer, A/B/C/B/A, biaxially oriented sleeve film is made by tenter frame orientation at 1.35 times in the machine direction and 8 times in the transverse direction. The C layer is a linear ethylene-octene copolymer with density 0.935, B layer is a blend with 50 wt % of C layer polymer and 50 wt % acid/acrylate grafted plastomer, and A layer is an amorphous copolyester. The sleeve label is made by folding the label film into a tube in the crosswise direction and sealing the edge by solvent. The sleeve label tube is fed onto the outer surface of the bottle and shrunk by heat.

### Example 2

A five layer, A/B/C/B/A, biaxially oriented sleeve film is made as Example 1. The sleeve label applied on the bottle is formed by the Example 1 method. The B and C layer polymers are the same as Example 1. The A layer comprises 70 wt % amorphous copolyester and 30 wt % acid/acrylate grafted plastomer.

### Example 3

A three-layer sleeve film structure, A/B/A, was made. The B-layer, which is a core layer, comprises 60 wt % of LLDPE, Mobil NTX-112, and 40 wt % of amorphous copolyester, Eastman Embrace P21214. The A-layer, which is a skin layer, comprises 80 wt % of Embrace P21214 and 20 wt % of Mitsui SE800 which is an acid/acrylate grafted plastomer. The film is made by tenter frame orientation at 1.35 times in MD orientation and 8 times in TD orientation. The core layer is about 60% of the total film thickness and each skin layer is about 20% of the total film thickness. The film is sealed into a tube by THF solvent, i.e. Tetrahydrofuran, for using as a sleeve label shrunk on the bottle by heat.

### Example 4

A three-layer sleeve film structure, A/B/A, was made. The B-layer, which is a core layer, comprises 50 wt % of LLDPE, Mobil NTX-112, and 50 wt % of amorphous copolyester, Eastman Embrace P21214. The A-Layer, which is a skin layer, comprises 80 wt% of Embrace P21214 and 20 wt % of Mitsui SE800 which is an acid/acrylate grafted plastomer. The film is made by tenter frame orientation at 1.35 times in MD orientation and 8 times in TD orientation. The core layer is about 60% of the total film thickness and each skin layer is about 20% of the total film thickness. The film is sealed into a tube by THF solvent for sleeve label application.

TABLE 1
Heat Shrinkage Data, at 250° F. for 7 minutes

Shrinkage

| Sample | MD | TD |
|---|---|---|
| Example 1 | 1.7% | 52% |
| Example 2 | 1.5% | 45% |
| Example 3 | 9% | 67% |
| Example 4 | 5% | 67% |

We claim:

1. A thermoplastic sleeve label comprising:
a. a core layer comprising a blend of at least one polyolefin and at least one amorphous copolyester, wherein the core layer comprises the interior of the label; and
b. a first skin layer comprising an amorphous copolyester, wherein the first skin layer is exterior to the core layer.

2. The thermoplastic sleeve label of claim 1 wherein the core layer comprises a material selected from the group consisting of linear polyethylene, propylene-ethylene copolymer, propylene-butene copolymer, polypropylene, and blends thereof.

3. The thermoplastic sleeve label of claim 1 wherein the first skin layer further comprises an acid/acrylate grafted plastomer.

4. The thermoplastic sleeve label of claim 1 further comprising:
a second skin layer comprising an amorphous copolyester, wherein the second skin layer is exterior to the core layer on a side of the core layer opposite the first skin layer.

5. The thermoplastic sleeve label of claim 1 further comprising:
a first tie layer comprising an amorphous copolyester, wherein the first tie layer is exterior to the core layer, and the first skin layer is exterior to the core layer and the first tie layer.

6. The thermoplastic sleeve label of claim 1 further comprising:
a second tie layer comprising an amorphous copolyester, wherein the second tie layer is exterior to the core layer on a side of the core layer opposite the first skin layer, and the second skin layer is exterior to the core layer and the second tie layer.

7. The thermoplastic sleeve label of claim 5 wherein the first tie layer has a thickness of at least about 0.1 mil.

8. The thermoplastic sleeve label of claim 6 wherein the second tie layer has a thickness of at least about 0.1 mil.

9. The thermoplastic sleeve label of claim 5 wherein the first tie layer further comprises the polymer of the core layer.

10. The thermoplastic sleeve label of claim 6 wherein the second tie layer further comprises the polymer of the core layer.

11. The thermoplastic sleeve label of claim 1 wherein the core layer is cavitated.

12. The thermoplastic sleeve label of claim 11 further comprising a cavitating agent selected from the group consisting of polyamides, polybutylene terephthalate, polyesters, acetals, acrylic resins, solid glass spheres, hollow glass spheres, metal beads, metal spheres, ceramic spheres, calcium carbonate, cyclic olefin copolymers, and mixtures thereof.

13. The thermoplastic sleeve label of claim 12 wherein the cavitating agent comprises calcium carbonate.

14. The thermoplastic sleeve label of claim 1 wherein the label has a thickness from about 1.5 mils to about 5 mils.

15. The thermoplastic sleeve label of claim 1 wherein the label has a thickness from about 1 mil to about 10 mils.

16. The thermoplastic sleeve label of claim 1 wherein the label is biaxially oriented.

17. The thermoplastic sleeve label of claim 1 wherein the first skin layer further comprises an additive selected from the group consisting of a slip agent, an antiblock agent, and blends thereof.

18. The thermoplastic sleeve label of claim 1 wherein the amorphous copolyester of the first skin layer comprises poly(1,4-cyclohexylenedimethylene/ethylene) terephthalate.

19. The thermoplastic sleeve label of claim 4 wherein the amorphous copolyester of the first skin layer comprises poly(1,4-cyclohexylenedimethylene/ethylene) terephthalate and the amorphous copolyester of the second skin layer comprises poly(1,4-cyclohexylenedimethylene/ethylene) terephthalate.

20. A thermoplastic sleeve label adapted to be applied to a container comprising:
a. a core layer comprising a blend of at least one polyolefin and at least one amorphous copolyester, wherein the core layer comprises the interior of the label; and
b. a first skin layer comprising an amorphous copolyester, wherein the first skin layer is exterior to the core layer.

21. A container having a thermoplastic sleeve label comprising:
a. a surface of the container;
b. an adhesive adjacent to the surface;
c. a label comprising a first skin layer comprising an amorphous copolyester and a core layer comprising a blend of at least one polyolefin and at least one amorphous polyester.

22. The container of claim 21 wherein the label further comprises a second skin layer comprising an amorphous copolyester.

23. A process for producing a thermoplastic sleeve label comprising the steps of:
a. coextruding a first skin layer comprising an amorphous copolyester, a core layer comprising a blend of at least one polyolefin and at least one amorphous copolyester, and a second skin layer comprising an amorphous copolyester;
b. orienting said label in the machine direction;
c. heat annealing said label;
d. treating said label with a treatment selected from the group consisting of plasma, corona, and flame treatment;
e. printing said label on at least one of the first skin layer and the second skin layer;
f. forming said label into a tube and sealing said label with a seal selected from the group consisting of solvent seal, heat seal, ultrasonic seal, and adhesive seal.

24. The process of claim 23 further comprising the step of orienting said film in the transverse direction.

25. The process of claim 23 further comprising the steps of placing said tube onto a container and shrinking said tube with the application of heat or UV light.
